(19) United States
(12) Patent Application Publication
(10) Pub. No.: US 2009/0043844 A1
(43) Pub. Date: Feb. 12, 2009

(54) SYSTEM AND METHOD FOR NAME CONFLICT RESOLUTION

(75) Inventors: Carol Sue Zimmet, Boxborough, MA (US); Ruthie D. Lyle, Durham, NC (US); Gary Denner, Co. Kildare (IE); Patrick Joseph O'Sullivan, Ballsbridge (IE)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/836,516

(22) Filed: Aug. 9, 2007

(51) Int. Cl. G06F 15/16

(52) U.S. Cl. 709/204

(57) ABSTRACT

A method of name conflict resolution including analyzing a plurality of relationships of a user. A social network of the user may be defined based upon at least a portion of the plurality of relationships, the social network identifying one or more relationship users. A name conflict may be resolved in a collaborative activity based upon, at least in part, the social network.

### TECHNICAL FIELD

This disclosure relates to contact directories and, more particularly, to name conflict resolution in social networking contact directories.

### BACKGROUND

Oftentimes individuals in an organization need to contact peers across the organization through email communications, instant messaging chats, and voice communications simply for communication reasons or for reasons such as scheduling calendar events and travel itineraries. In large organizations with a large number of user names, in which there may be many duplicate names, it may be difficult to determine which person is the desired contact when presented with duplicate names in the directory and without more information about each individual. For example, without more information, it may be difficult for a user to choose which John Smith is the intended recipient of an email communication from a list including, for example, John A Smith and John B Smith.

Additionally, making the choice between duplicate names may become more challenging if the user has contacted each of the duplicate parties in the past, resulting in both names appearing in the user's frequent contacts list. Further, choosing one of the duplicate names may be worrisome, and potentially embarrassing, when confronted with the possibility of erroneously contacting the wrong person, who happens to be a higher ranking member of the organization than the user.

### SUMMARY OF THE DISCLOSURE

In a first implementation, a method includes analyzing a plurality of relationships of a user. A social network of the user may be defined based upon at least a portion of the plurality of relationships, the social network identifying one or more relationship users. A name conflict may be resolved in a collaborative activity based upon, at least in part, the social network.

One or more of the following features may be included. The plurality of relationships of the user may include one or more of: email communications, instant messaging chats, voice communications, scheduled calendar events, and travel itineraries. The collaborative activity may include one or more of: email communications, instant messaging chats, voice communications, scheduled calendar events, and travel itineraries.

The name conflict may result from two or more similar names in a network directory. Resolving the name conflict in the collaborative activity may include comparing the two or more similar names in the network directory with the one or more relationship users, and selecting the relationship user if the relationship user is one of the two or more similar names.

Defining the social network may include associating a relationship weighting parameter with the one or more relationship users based upon, at least in part, a relationship strength. The relationship strength may be indicated by, at least in part, a frequency of contact. The relationship strength may be indicated by, at least in part, a degree of separation between the user and the relationship user in an organizational structure.

According to another implementation, a computer program product may reside on a computer readable medium, which may have a plurality of instructions stored thereon. When executed by a processor, the instructions cause the processor to perform operations including analyzing a plurality of relationships of a user. The instructions further cause the processor to define a social network of the user based upon at least a portion of the plurality of relationships, the social network identifying one or more relationship users. The instructions further cause the processor to resolve a name conflict in a collaborative activity based upon, at least in part, the social network.

One or more of the following features may be included. The plurality of relationships of the user may include one or more of: email communications, instant messaging chats, voice communications, scheduled calendar events, and travel itineraries. The collaborative activity may include one or more of: email communications, instant messaging chats, voice communications, scheduled calendar events, and travel itineraries.

The name conflict may result from two or more similar names in a network directory. The instructions for resolving the name conflict in the collaborative activity may include instructions for comparing the two or more similar names in the network directory with the one or more relationship users, and instructions for selecting the relationship user if the relationship user is one of the two or more similar names.

The instructions for defining the social network may include instructions for associating a relationship weighting parameter with the one or more relationship users based upon, at least in part, a relationship strength. The relationship strength may be indicated by, at least in part, a frequency of contact. The relationship strength may be indicated by, at least in part, a degree of separation between the user and the relationship user in an organizational structure.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a name conflict resolution process and a relationship application coupled to a distributed computing network.

FIG. 2 is a flowchart of a process executed by the name conflict resolution process of FIG. 1.

FIG. 3 is a diagrammatic view of an organizational hierarchal structure included in the corporate directory of FIG. 1.

FIG. 4 is a diagrammatic view of a weighted social network defined by the name conflict resolution process of FIG. 1.

FIG. 5 is an illustration of a user interface rendered by the name conflict resolution process and/or a relationship client application of FIG. 1.

### DETAILED DESCRIPTION

### System Overview

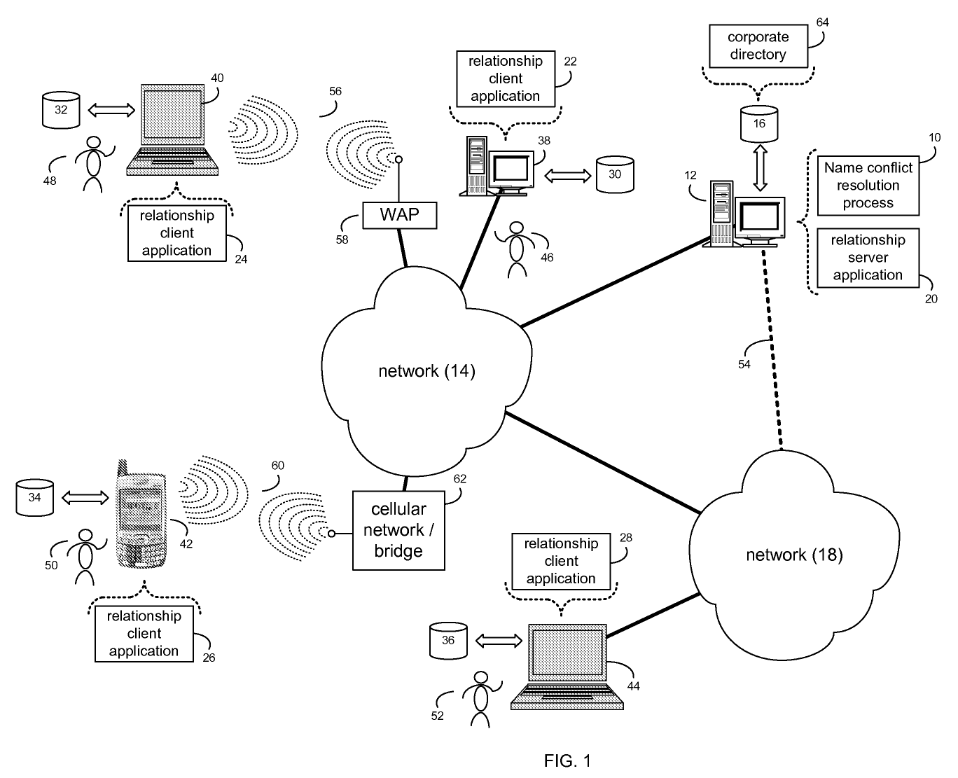

Referring to FIG. 1, there is shown name conflict resolution process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. In addition/as an alternative, name conflict resolution process 10 may reside on and may be executed by one or more client electronic devices, such as personal computer, a notebook computer, a personal digital assistant, and a data enable cellular phone, for example.

As will be discussed below in greater detail, name conflict resolution process 10 may enable a user to resolve name conflicts due to similar user names in a directory. The name conflict resolution may be based upon, at least in part, one or more relationships of the user. To accomplish this, name conflict resolution process 10 may analyze one or more relationships of the user, define a social network of the user, identify one or more relationship users, and resolve a name conflict in a collaborative activity based upon, at least in part, the social network.

Name conflict resolution process 10 may analyze relationships of a user including, but not limited to, the user's email communications, instant messaging chats, voice communications, events scheduled in a calendar or appointment scheduling applications, and travel itineraries, for example. The social network may include, for example, contact information for one or more other users, including, but not limited to, email addresses, instant messaging user identification, telephone numbers, mailing addresses, company and position information, biographical information, and the like.

The instruction sets and subroutines of name conflict resolution process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more relationship server applications (e.g., relationship server application 20), examples of which may include but are not limited to email server applications that may include calendar and/or scheduling modules or components (e.g., Lotus Domino™ Server and Microsoft Exchange™ Server), instant messaging server applications (e.g., IBM Lotus Sametime™, Microsoft Office Live Communications Server™, Jabber XCP™, and AOL Instant Messenger™), voice over IP server applications or PBX telephone systems. Relationship server application 20 may interact with relationship client applications 22, 24, 26, 28, examples of which may include, but are not limited to, email client applications that may include calendar and/or scheduling modules (e.g., Lotus Notes™ and Microsoft Outlook™), instant messaging client applications (e.g., AOL Instant Messenger™, IBM Lotus Sametime™, Google Talk™), voice over IP client applications, and softphone applications. Name conflict resolution process 10 may be a stand alone application that interfaces with relationship server application 20 or may be an applet/application that is executed within relationship server application 20.

The instruction sets and subroutines of relationship server application 20, which may be stored on storage device 16 coupled to server computer 12, may be executed by one or more processors (not shown) and one or more memory architectures (not shown) incorporated into server computer 12.

As mentioned above, in addition/as an alternative to being a server-based application residing on server computer 12, the name conflict resolution process 10 may be a client-side application (not shown) residing on one or more client electronic device 38, 40, 42, 44 (e.g., stored on storage device 30, 32, 34, 36, respectively). As such, the name conflict resolution process 10 may be a stand alone application that interfaces with a relationship client application (e.g., relationship client applications 22, 24, 26, 28), or may be an applet/application that is executed within a relationship client application. As such, the name conflict resolution process 10 may be a client-side process, a server-side process, or a hybrid client-side/server-side process, which may be executed, in whole or in part, by server computer 12, or one or more of client electronic device 38, 40, 42, 44.

The instruction sets and subroutines of relationship client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using relationship client applications 22, 24, 26, 28, users 46, 48, 50, 52 may engage in relationship activities (e.g., send/receive email communications, conduct instant messaging chats, schedule calendar events, conduct telephone conversations, and similar activities). Engaging in relationship activities may include accessing relationship server application 20.

Users 46, 48, 50, 52 may access relationship server application 20 directly through the device on which the relationship client application (e.g., relationship client applications 22, 24, 26, 28) is executed, namely client electronic devices 38, 40, 42, 44, for example. Users 46, 48, 50, 52 may access relationship server application 20 directly through network 14 or through secondary network 18. Further, server computer 12 (i.e., the computer that executes relationship server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Name Conflict Resolution Process

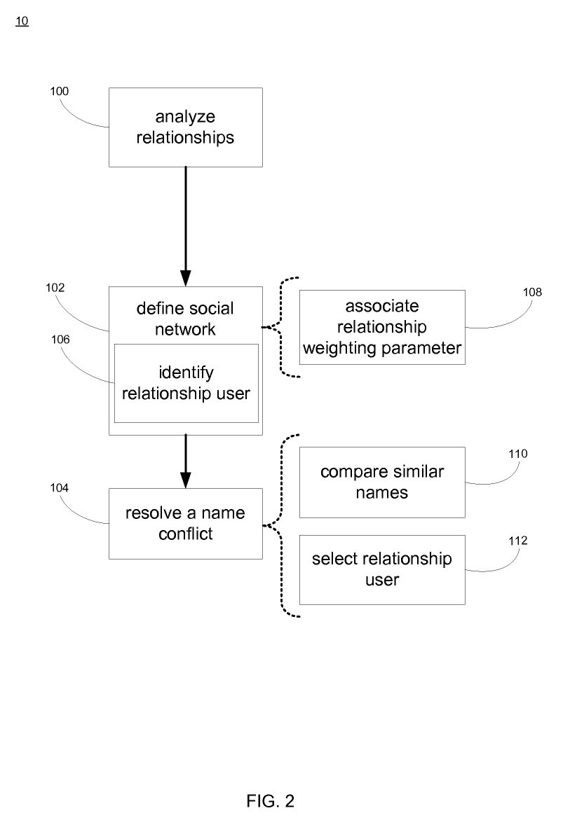

Referring also to FIG. 2, name conflict resolution process 10 may analyze 100 a plurality of relationships of a user, and may define 102 a social network based upon at least a portion of the relationships of the user. Name conflict resolution process 10 may resolve 104 a name conflict in a collaborative activity based upon, at least in part, the social network

The plurality of relationships of the user may include, for example, one or more of: email communications, instant messaging chats, voice communications, scheduled calendar events, and travel itineraries, and inclusion in a work group (e.g., team or department). For example, user 46 may send and/or receive an email to/from user 48. Additionally, user 46 may conduct an instant messaging chat with user 50. User 46 may schedule a meeting with user 52. The scheduled meeting with user 52 may be explicit (e.g., a meeting may be scheduled between user 46 and user 52, or user 46 may accept a meeting schedule from user 52) or may be implicit (e.g., user 46 and user 52 may each be scheduled for a meeting at the same time and place). Furthermore, user 46 may initiate and/or receive a telephone call from another user (e.g., which may be logged by an enterprise telephone system or a caller ID system/module). Users 46, 48, and 50 may also take a business trip together (e.g., evidenced based on group travel arrangements, commonly scheduled events in a calendar application, or the like).

The plurality of relationships of the user may be conducted using one or more relationship client applications (e.g., relationship client applications 22, 24, 26, 28, for example), and may, for example, involve interaction with a relationship server application (e.g., relationship server application 20). Continuing with the above-stated example, user 46 may send/receive the email to/from user 48 via an email applicaiton. Similarly, user 46 may conduct the instant messaging chat with user 50 via an instant messaging application. User 46 may initiate/receive a telephone call via a voice communication application, and may schedule a meeting with user 52 via a calendar/scheduling application. Various other relationship activities and applications may also be used.

Name conflict resolution process 10 may define 102 one or more social networks for the user based upon at least a portion of the plurality of relationships of the user. The social networks defined 102 for the user may identify 106 one or more relationship users. In part, the social network defined 102 for the user may include people with whom the user has a relationship, e.g., as indicated by email, instant messaging, and voice communications, and by common appointments and travel arrangements, as discussed above. Additionally/alternatively, the user's social network may include people with whom the user works, e.g., based upon, at least in part, a corporate, or similar, directory (e.g., associations by department, work group, and the like indicated in a corporate directory), also as discussed above.

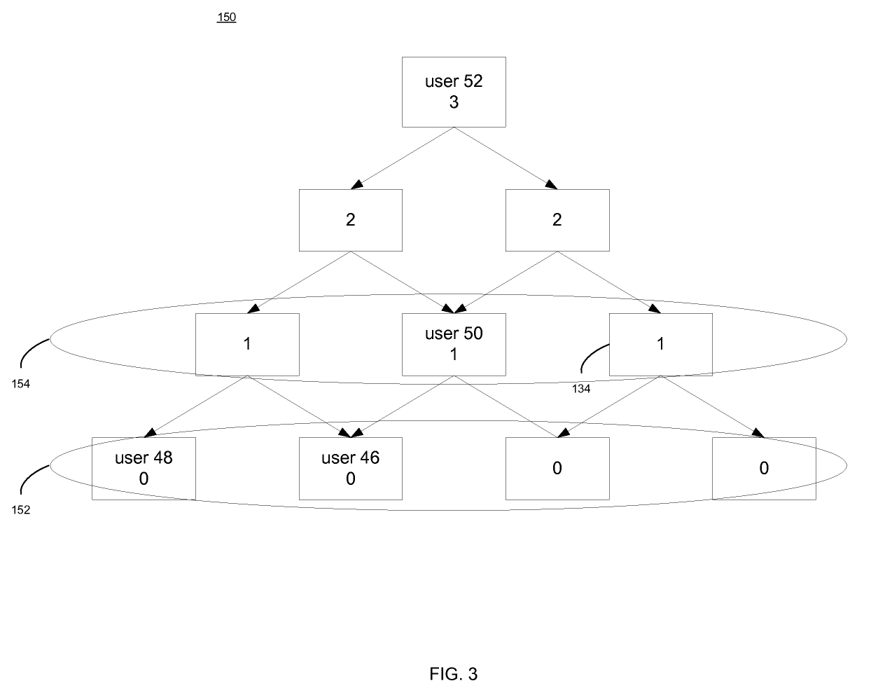

For example, an referring also to FIG. 3, the social network defined 102 for user 46 may be based upon, at least in part, a corporate or similar directory (e.g., corporate directory 64 residing on storage device 16 of server computer 12). The social network may be based upon, at least in part, a degree of separation between user 46 and the other users (e.g., users 48, 50, 52) within organizational hierarchy 150. For example, user 46's peers (e.g., user 48) may be located within a common hierarchal tier (e.g., tier 152) as user 46, providing zero degree of separation between user 46 and user 48. Correspondingly, user 46's immediate supervisor (e.g., user 50) may be located one tier above user 46 (e.g., on tier 154), providing one degree of separation between user 46 and user 50. Additional users may be located on further tiers in organizational hierarchy 150 providing corresponding degrees of separation from user 46.

Continuing with the above-stated example, name conflict resolution process 10 may define 102 a social network for user 46 that may identify 106 one or more relationship users within a defined degree of separation of user 46 (e.g., one or two degrees of separation above and below user 46). The defined degree of separation may be defined by user 46 or by a general policy. The defined degree of separation may be selected, at least in part, to encompass the individuals that user 46 may likely interact with on a regular/semi-regular basis. Additionally, the social network may include a specific group within the organization structure (e.g., a given department or branch of the organizational hierarchy). Various other mechanisms for defining the user's social network may also be used.

A name conflict may result from two or more users having similar names, for example in a network directory (e.g., corporate directory 64). For example, a user may wish to communicate with a given individual, however, the network directory may include entries for the individual that the user wished to communicate with and for another person having a similar name. This situation may make it difficult for the user to determined which entry corresponds to the individual that the user actually wishes to communicate with. Name conflict resolution process 10 may resolve 104 the name conflict in a collaborative activity based upon, at least in part, the social network defined 102 the user. As in the above-discussed relationships of the user (based upon which, at least in part, the social network may be defined 102), the collaborative activity may include one or more of: email communications, instant messaging chats, voice communications, scheduled calendar events, and travel itineraries.

For example, corporate directory 64 may include two or more entries for the name John Smith, with one entry corresponding to user 48 and another entry corresponding to user 52. Name resolution process 10 may allow user 46 to determine which John Smith (e.g., user 48 or user 52) to email based upon, at least in part, a presence of user 48 or user 50 in the social network defined for user 46. For example, user 46 may regularly engage in collaborative activities (e.g., email, instant messaging, voice communication, scheduled meetings) with user 48, but may rarely engage in collaborative activities with user 52. It may, therefore, be more likely that user 46 wishes to send an email to the John Smith entry in corporate directory 64 corresponding to user 48 and not to the John Smith entry corresponding to user 52.

To resolve 104 the name conflict, name conflict resolution process 10 may associate 108 a relationship weighting parameter with one or more relationship users in the defined 102 social network. Name conflict resolution process 10 may associate 108 a relationship weighting parameter with one or more relationship user based upon, at least in part, a perceived relationship strength. The relationship strength of the one or more relationship users may be based upon, at least in part, a frequency of contact, a degree of separation in a corporate or other directory (e.g., corporate directory 64), or other similar factor.

For example, user 46 may regularly email and instant message user 48, indicating a relatively high relationship strength. Similarly, user 50 may have one degree of separation from user 46 is corporate directory 64, also suggestion a relatively high relationship strength. However, user 46 may rarely interact with (e.g., email, instant message, call, or attend meetings) user 52. Additionally, there may be three degrees of separation between user 46 and user 52 in corporate directory 64. The infrequent interaction and relatively high degree of separation between user 46 and user 52 may suggest a relatively weak relationship strength.

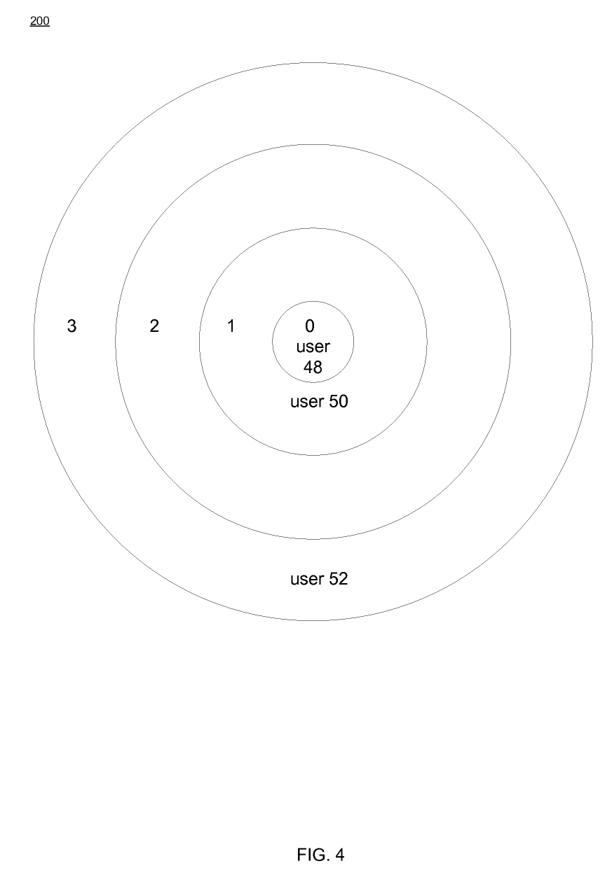

Continuing with the above-stated example, and referring also to FIG. 4, a diagrammatic depiction of a weighted social network 200 for user 46 may include relationship users (e.g., users 48, 50, 52) arranged according to a relationship weighting parameter associated 108 with each of users 48, 50, 52. For example, name conflict resolution process 10 may associate 108 a relationship weighting parameter of 0 with user 48, indicating a relatively high relationship strength (e.g., a closeness in collaboration frequency or likelihood with user 46). Similarly, name conflict resolution process 10 may associate 108 a relationship weighting parameter of 1 with user 50, also indicating a relatively high relationship strength between user 46 and user 50. However, the relationship strength between user 46 and user 50 may be lower than the relationship strength between user 46 and user 48. Name conflict resolution process 10 may associate 108 a relationship weighting parameter of 3 with user 52, indicating a relatively weak relationship strength (e.g., based upon, at least in part, relatively infrequent interaction and/or relatively high degree of separation in an organization hierarchy).

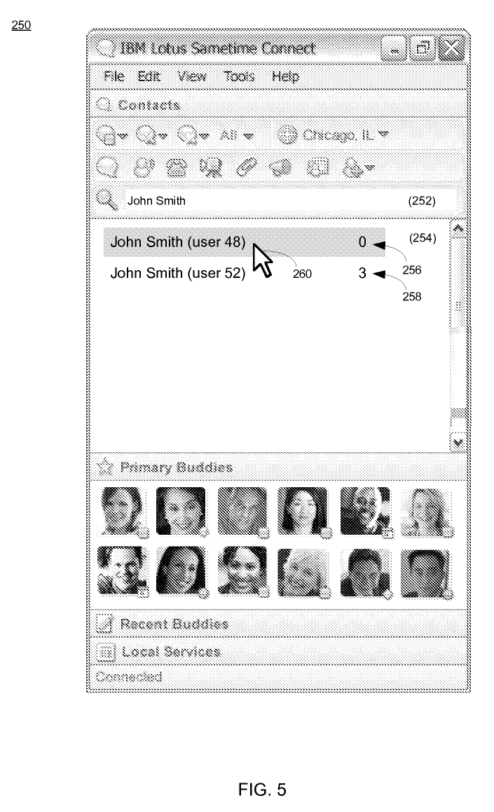

Name conflict resolution process 10 may resolve 104 a name conflict in a collaborative activity by comparing 110 the two or more similar names in the network directory with one or more relationship users included in the social network defined 102 for a user. Continuing with the above-stated example, user 46 may wish to send an instant message to John Smith. Referring also to FIG. 5, instant message user interface 250 (rendered by instant messaging application, e.g., relationship client application 22) may include contact search field 252. User 46 may search for a desired contact having the name “John Smith” (e.g., by inputting the name “John Smith” in contact search field 252 using a keyboard; not shown). The instant messaging application may return two possible users (e.g., user 48, 52) with the name “John Smith” (e.g., based upon the users included in corporate directory 64), for example, in search result block 254 of instant messaging user interface 250. One or both of users 48, 52 having the name “John Smith” may be included in the social network defined 102 for user 46.

Name conflict resolution process 10 and/or the instant messaging application may display relationship weighting parameters 256, 258 associated 108 with each relationship user (e.g., user 48, 52). For example, name conflict resolution process 10 and/or the instant messaging application may display relationship weighting parameter 256 having a value of 0 (indicating a relatively high relationship strength) with the entry associated 108 with user 48. Similarly, name conflict resolution process 10 and/or the instant messaging application may display relationship weighting parameter 258 having a value of 3 (indicating a relatively low relationship strength) associated 108 with user 52. User 46 may select (e.g., using onscreen pointer 260 controlled by a pointing device such as a mouse; not shown) a desired entry (e.g., user 48, user 52) based upon, at least in part displayed relationship weighting parameters 256, 258.

Additionally/alternatively, name conflict resolution process 10 may select 112 (e.g., by highlighting) one or more entry corresponding to a relationship user if one of the two or more similar names is included within the social network defined 102 for user 46. Furthermore, if more than one entry corresponds to a relationship user, name conflict resolution process 10 may select 112 the relationship user having an associated 108 relationship weighting parameter (e.g., displayed relationship weighting parameters 152, 154) indicating a stronger relationship. For example, user 48 may have an associated 108 relationship weighting parameter of 0 and user 52 may have an associated 108 relationship weighting parameter of 3. As such, name conflict resolution process 10 may select 112 (e.g., by highlighting) the entry corresponding to user 48 based upon, at least in part, the stronger relationship indicated by displayed relationship weighting parameter 256.

A number of implementations have been described. Nevertheless, it will be understood that various modifications may be made. Accordingly, other implementations are within the scope of the following claims.

What is claimed is:

1. A method comprising:
analyzing a plurality of relationships of a user;
defining a social network of the user based upon at least a portion of the plurality of relationships, the social network identifying one or more relationship users; and
resolving a name conflict in a collaborative activity based upon, at least in part, the social network.

2. The method of claim 1, wherein the plurality of relationships of the user include one or more of: email communications, instant messaging chats, voice communications, scheduled calendar events, and travel itineraries.

3. The method of claim 1, wherein the collaborative activity includes one or more of: email communications, instant messaging chats, voice communications, scheduled calendar events, and travel itineraries.

4. The method of claim 1, wherein the name conflict results from two or more similar names in a network directory.

5. The method of claim 4, wherein resolving the name conflict in the collaborative activity includes comparing the two or more similar names in the network directory with the one or more relationship users, and selecting the relationship user if the relationship user is one of the two or more similar names.

6. The method of claim 1, wherein defining the social network includes associating a relationship weighting parameter with the one or more relationship users based upon, at least in part, a relationship strength.

7. The method of claim 6, wherein the strength of the relationship is indicated by, at least in part, a frequency of contact.

8. The method of claim 6, wherein the strength of the relationship is indicated by, at least in part, a degree of separation between the user and the relationship user in an organizational structure.

9. A computer program product residing on a computer readable medium having a plurality of instructions stored thereon which, when executed by a processor, cause the processor to perform operations comprising:
analyzing a plurality of relationships of a user;
defining a social network of the user based upon at least a portion of the plurality of relationships, the social network identifying one or more relationship users; and
resolving a name conflict in a collaborative activity based upon, at least in part, the social network.

10. The computer program product of claim 9, wherein the plurality of relationships of the user include one or more of: email communications, instant messaging chats, voice communications, scheduled calendar events, and travel itineraries.

11. The computer program product of claim 9, wherein the collaborative activity includes one or more of: email communications, instant messaging chats, voice communications, scheduled calendar events, and travel itineraries.

12. The computer program product of claim 9, wherein the name conflict results from two or more similar names in a network directory.

13. The computer program product of claim 12, wherein resolving the name conflict in the collaborative activity includes comparing the two or more similar names in the network directory with the one or more relationship users, and selecting the relationship user if the relationship user is one of the two or more similar names.

14. The computer program product of claim 9, wherein defining the social network includes associating a relationship weighting parameter with the one or more relationship users based upon, at least in part, a relationship strength.

15. The computer program product of claim 14, wherein the strength of the relationship is indicated by, at least in part, a frequency of contact.

16. The computer program product of claim 14, wherein the strength of the relationship is indicated by, at least in part, a degree of separation between the user and the relationship user in an organizational structure.
